(19) United States
(12) Patent Application Publication
(10) Pub. No.: US 2018/0098512 A1
(43) Pub. Date: Apr. 12, 2018

(54) GARDEN RING SYSTEM

(71) Applicant: Theresa Robeck, Danbury, WI (US)

(72) Inventor: Theresa Robeck, Danbury, WI (US)

(21) Appl. No.: 15/595,507

(22) Filed: May 15, 2017

Related U.S. Application Data
(60) Provisional application No. 62/405,823, filed on Oct. 7, 2016.

(51) Int. Cl. A01G 9/02; A01G 9/00

(52) U.S. Cl. CPC A01G 9/02; A01G 9/10; A01G 9/006

(57) ABSTRACT

A garden ring system includes a planting apparatus having a bottom-less pot including an outer wall, an inner cavity, a first-opening, and a second-opening. The bottom-less pot is able to be placed around a garden plant or tree to promote growth. The device keeps moisture in the immediate area of the tree or plant to ensure that water surrounds the plant and keeps the ground moist for extended periods of time.

### CROSS REFERENCE TO RELATED APPLICATION

The present application is related to and claims priority to U.S. Provisional Patent Application No. 62/405,823 filed Oct. 7, 2016, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present invention relates generally to the field of planting pots and more specifically relates to a garden ring system.

### 2. Description of Related Art

Gardening is considered to be a relaxing activity for many people. It is the practice of growing and cultivating plants. In gardens, ornamental plants are often grown for their flowers, foliage, or overall appearance; useful plants, such as root vegetables, leaf vegetables, fruits, and herbs, are grown for consumption. When maintaining a garden, it is important that the soil stay moist in order to promote plant growth. Individuals may water the area daily; however, the water tends to disperse away from the plant and its roots. When the water does not reach the plant and keep the soil moist, the plant quickly dries up. In addition, plant fertilizer and accelerant are often washed away before they are able to fully seep into the soil and feed the plant. It is difficult to keep the necessary hydration and nutrients surrounding the plant in order for the plant to thrive. A suitable solution is desired.

U.S. Pub. No. 2012/0227316 to Brenda Ptak relates to a planting apparatus and methods. The described planting apparatus and methods includes improved planting pots and methods. Specifically, the invention provides methods and apparatuses that assist gardeners in transplant cultivation, plant protection and containment, garden organization, decoration, and plant identification.

### BRIEF SUMMARY OF THE INVENTION

In view of the foregoing disadvantages inherent in the known planting pot art, the present disclosure provides a novel garden ring system. The general purpose of the present disclosure, which will be described subsequently in greater detail, is to provide a plastic bottomless pot that is designed to be placed around a garden plant or tree/vegetation to promote growth.

A garden ring system is disclosed herein. The garden ring system includes a planting apparatus having a bottom-less pot which includes an outer wall, an inner cavity, a first-opening, and a second-opening. The garden ring system comprises the planting apparatus. The planting apparatus comprises the bottom-less pot which is defined by the outer wall, the inner cavity, the first-opening and the second-opening.

The bottom-less pot may comprise a substantially cylindrical profile. The bottom-less pot preferably comprises a semi-rigid material which may include durable plastic or other suitable material. In a preferred embodiment, the bottom-less pot may comprise a thickness of approximately 0.125-inch. The first-opening comprises a rim configured to encircle a plant planted within the inner cavity. The first-opening and the second-opening comprise a circular profile thereby creating a cylindrical profile. The rim may comprise a greater diameter than the first-opening. The first-opening and the second-opening are preferably similar in diameter, with the second-opening being slightly smaller such that they are easy to stack and ship. The second-opening comprises an open end and includes staggered edges configured to make the present invention readily insertable into a ground surface. The staggered edges comprise a w-shaped profile providing sharp edges for penetrating the ground surface. The unit may be placed around a plant and pushed into the ground or tapped in using a rubber hammer. The second-opening is configured to permit and encourage horizontal root growth from the inner cavity of the bottom-less pot beneath the ground surface.

The bottom-less pot comprises plastic in preferred embodiments creating a barrier for containing and retaining moisture, fertilizer and other nutrients within the inner cavity within the immediate area of the tree or plant to ensure that the moisture surrounds the plant and keeps the ground moist for days. The outer wall of the bottom-less pot comprises an identification tag slot for inserting at least one identification tag. The identification tag comprises indicia to indicate plant-types and other useful information. The identification tag slot is preferably located near a first-opening of the outer wall of the bottom-less pot. The bottom-less pot is configured to be inserted approximately 4-inches into soil beneath the ground surface. The bottom-less pot comprises the inner cavity large enough to accommodate the plants. Variations may be made in a similar fashion, but with a thicker material and a larger lip to fit around a tree and accommodate mulch. Sizes of the units may vary based on the size of plants or trees. The plants are able to be planted into the inner cavity of the bottom-less pot and be inserted into the ground surface to retain moisture, fertilizer, and nutrients for optimal growth.

A method of using garden ring system is also disclosed herein. The method of using garden ring system may comprise the steps of: inserting a bottom-less pot into a ground surface, applying downward pressure about a rim of a first-opening of the bottom-less pot, planting a plant within an inner cavity of the bottom-less pot, and removing the bottom-less pot.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a garden ring system, constructed and operative according to the teachings of the present disclosure.

FIG. 1 is a perspective view of the garden ring system during an ‘in-use’ condition, according to an embodiment of the disclosure.

FIG. 2 is a perspective view of the garden ring system of FIG. 1, according to an embodiment of the present disclosure.

FIG. 3 is a perspective view of the garden ring system of FIG. 1, according to an embodiment of the present disclosure.

FIG. 4 is a top view of the garden ring system of FIG. 1, according to an embodiment of the present disclosure.

FIG. 5 is a flow diagram illustrating a method of use for garden ring system, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a planting pot and more particularly to a garden ring system as used to improve the efficiency of plant growth.

Generally, the present invention provides a plastic bottom-less pot that is designed to be placed around a garden plant or tree to promote growth. The present invention keeps moisture in an immediate area of the tree or garden plant to ensure that water surrounds the plant and keeps the ground moist for extended periods of time. It secures any mulch surrounding the tree to prevent the mulch from drifting away, resulting in an untidy and unprofessional appearance. It prevents fertilizer and plant accelerant from being washed away by hard rains or excessive watering. The present invention includes an identification tag slot for holding plant tags to enable owners to identify the plant placed in each pot.

Garden ring system for plants and trees is configured to keep water, fertilizer, and mulch in the immediate area surrounding a plant or tree. The unit may also be used to keep tomato cages upright. The device includes a bottom-less pot made from a durable plastic that measures approximately 0.125-inch thick with a lip on the top. The unit may be placed around the plant and pushed into the ground or tapped in using a rubber hammer. The portion that is pushed into the ground is comprised of several staggered edges, similar to a w-shape all the way around. The garden ring system may include a tree variation comprising a thicker material and a larger lip to accommodate larger plants such as a tree and also accommodate mulch. Sizes of the units may vary based on the size of the plants or trees. The exact specifications may vary.

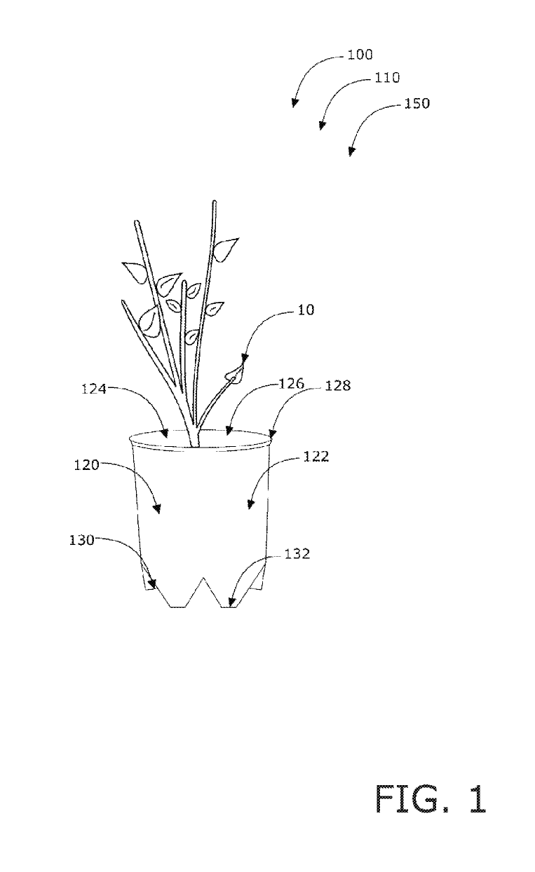

Referring now more specifically to the drawings by numerals of reference, there is shown in FIGS. 1-4, various views of a garden ring system 100. FIG. 1 shows a garden ring system 100 during an ‘in-use’ condition 150, according to an embodiment of the present disclosure. As illustrated, the garden ring system 100 may include a planting apparatus 110 comprising a bottom-less pot 120 having an outer wall 122, an inner cavity 124, a first-opening 126, and a second-opening 130. The garden ring system 100 comprises the planting apparatus 110. The planting apparatus 110 comprises the bottom-less pot 120. The bottom-less pot 120 is defined by the outer wall 122, the inner cavity 124, the first-opening 126 and the second-opening 130. In a preferred embodiment, the bottom-less pot 120 comprises a cylindrical profile. The first-opening 126 and the second-opening 130 are similar in diameter, second-opening 130 slightly smaller than first-opening 126. The bottom-less pot 120 may be semi-rigid providing a desired rigidity allowing a user to tap the device into a ground surface using a hammer or other suitable tool. In a preferred embodiment, the bottom-less pot 120 comprises a thickness of approximately 0.125-inch. The first-opening 126 comprises a rim 128 configured to encircle a plant 10 planted within the inner cavity 124.

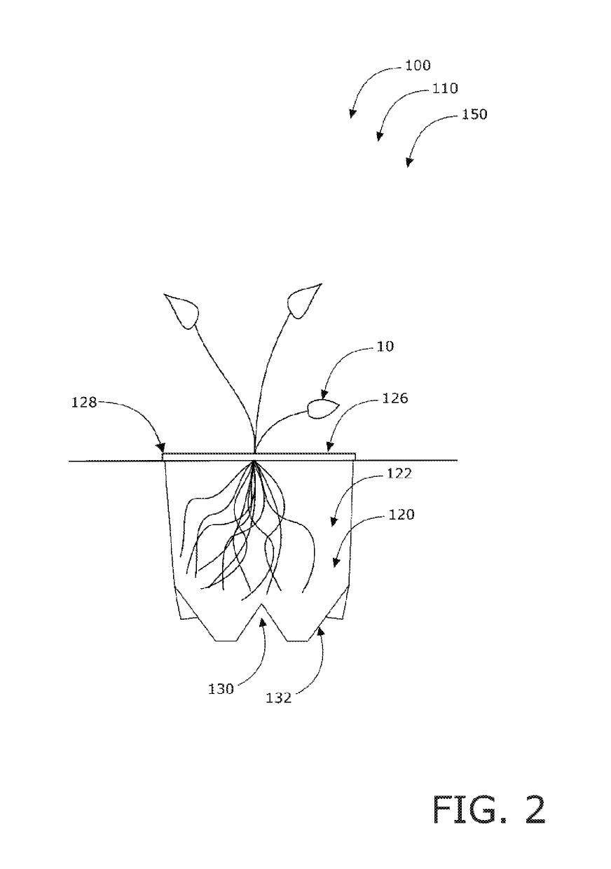

FIG. 2 shows a perspective view of the garden ring system 100 of FIG. 1, according to an embodiment of the present disclosure. As above, the garden ring system 100 may include a planting apparatus 110 having a bottom-less pot 120 including an outer wall 122, an inner cavity 124, a first-opening 126, and a second-opening 130. The second-opening 130 comprises an open end and includes staggered edges 132 configured to be inserted into a ground surface. The staggered edges 132 comprise a w-shaped profile or other suitable shape providing sharp edges for penetrating the ground surface. The second-opening 130 is configured to permit and encourage horizontal root growth from the inner cavity 124 of the bottom-less pot 120 beneath the ground surface. The bottom-less pot 120 is able to be placed around a plant 10 or tree to promote growth. The device keeps moisture in the immediate area of the tree or plant 10 to ensure that water surrounds the plant 10 and keeps the ground moist for extended periods of time. The bottom-less pot 120 may comprise plastic or other suitable material thereby creating a barrier for containing and retaining moisture and fertilizer within the inner cavity 124.

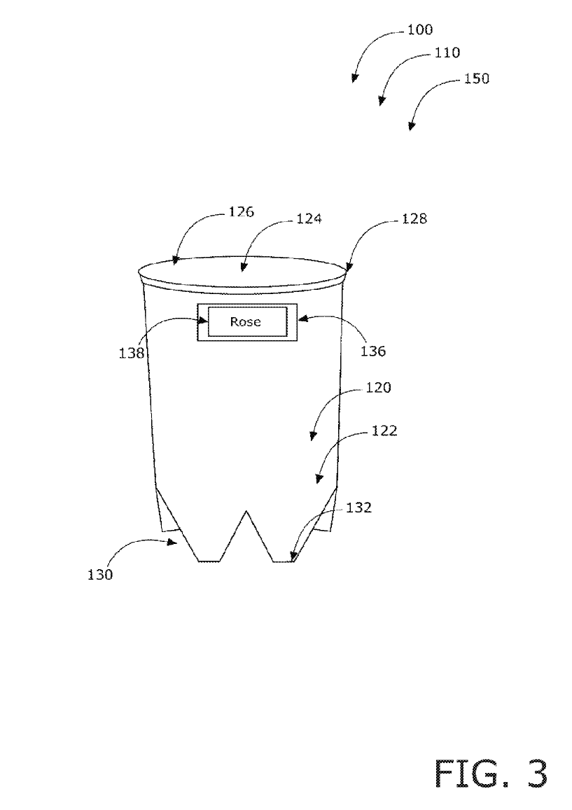

FIG. 3 shows a front perspective view of the garden ring system 100 of FIG. 1, according to an embodiment of the present disclosure. As above, the garden ring system 100 may include the bottom-less pot 120 which may comprise plastic creating a barrier for containing and retaining moisture and fertilizer within the inner cavity around an immediate area of the plant 10. The device allows for optimal root absorption of nutrients. The outer wall 122 of the bottom-less pot may comprise an identification tag slot 136 for inserting at least one identification tag 138. The identification tag 138 comprises indicia to indicate plant-types and other useful information. The identification tag slot 136 may be located near a first-opening 126 of the outer wall 122 of the bottom-less pot 120. The bottom-less pot 120 is configured to be inserted approximately 4-inches into soil beneath the ground surface. The bottom-less pot 120 comprises the inner cavity 124 large enough to accommodate the plants 10. The plants 10 are able to be planted into the inner cavity 124 of the bottom-less pot 120 and be inserted into the ground surface to retain moisture, fertilizer, and nutrients for optimal growth.

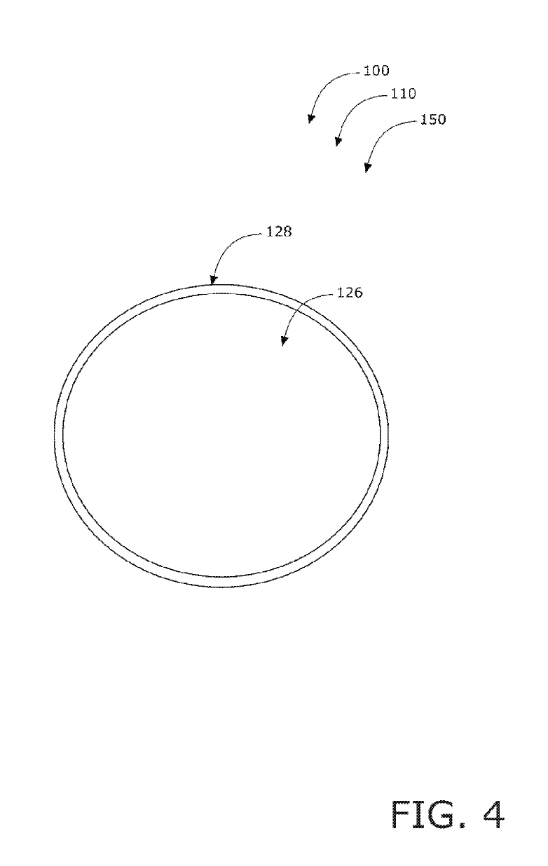

FIG. 4 shows a top view of the garden ring system 100 of FIG. 1, according to an embodiment of the present disclosure. As above, the garden ring system 100 may include a planting apparatus 110 comprising a bottom-less pot 120 having a first-opening 126. The first-opening 126 comprises a circular profile. The rim 128 comprises a greater diameter than the first-opening 126 creating a lip. The device prevents fertilizer and plant accelerant from being washed away by hard rains or excessive watering.

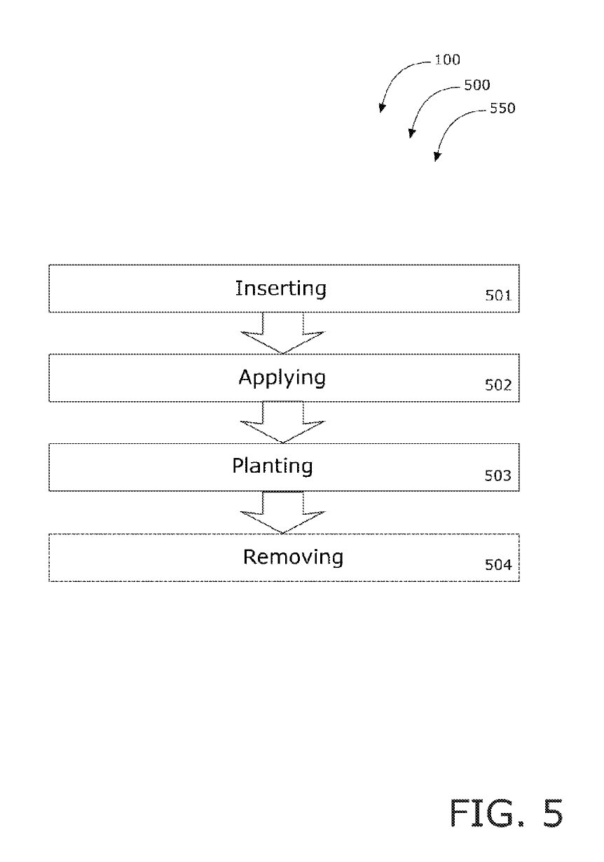

Referring now to FIG. 5, a flow diagram 550 illustrating a garden ring system 100, according to an embodiment of the present disclosure. As illustrated, the garden ring system 100 may include a method of use 500 including the steps of: step one 501 inserting a bottom-less pot 120 into a ground surface, step two 502 applying downward pressure about a rim 128 of a first-opening 126 of the bottom-less pot 120, step three 503 planting a plant 10 within an inner cavity 124 of the bottom-less pot 120, and step four 504 removing the bottom-less pot 120.

It should be noted that step four 504 is an optional step and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for garden ring system 100 (e.g., different step orders within above-mentioned list, elimination or addition of certain steps, including or excluding certain maintenance steps, etc.), are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A garden ring system comprising:
a planting apparatus including;
a bottom-less pot having;
an outer wall;
an inner cavity;
a first-opening; and
a second-opening;
wherein said garden ring system comprises said planting apparatus;
wherein said planting apparatus comprises said bottom-less pot;
wherein said bottom-less pot is defined by said outer wall, said inner cavity, said first-opening and said second-opening;
wherein said first-opening comprises a rim configured to encircle a plant planted within said inner cavity;
wherein said second-opening comprises an open end and includes staggered edges configured to be inserted into a ground surface; and
wherein said plants are able to be planted into said inner cavity of said bottom-less pot and be inserted into said ground surface to retain moisture, fertilizer, and nutrients for optimal growth.

2. The garden ring system of claim 1, wherein said bottom-less pot comprises a cylindrical profile.

3. The garden ring system of claim 1, wherein said bottom-less pot comprises a thickness of approximately 0.125-inch.

4. The garden ring system of claim 1, wherein said rim comprises a greater diameter than said first-opening.

5. The garden ring system of claim 1, wherein said staggered edges comprise a w-shaped profile providing sharp edges for penetrating said ground surface.

6. The garden ring system of claim 1, wherein said second-opening is configured to permit and encourage horizontal root growth from said inner cavity of said bottom-less pot beneath said ground surface.

7. The garden ring system of claim 1, wherein said bottom-less pot comprises plastic creating a barrier for containing and retaining moisture and fertilizer within said inner cavity.

8. The garden ring system of claim 1, wherein said outer wall of said bottom-less pot comprises an identification tag slot for inserting at least one identification tag.

9. The garden ring system of claim 8, wherein said identification tag comprises indicia.

10. The garden ring system of claim 9, wherein said indicia indicates plant-types.

11. The garden ring system of claim 1, wherein said first-opening and said second-opening comprise a circular profile.

12. The garden ring system of claim 11, wherein said first-opening and said second-opening are similar in diameter, said second-opening slightly smaller than said first-opening.

13. The garden ring system of claim 12, wherein said identification tag slot is located near a first-opening of said outer wall of said bottom-less pot.

14. The garden ring system of claim 1, wherein said bottom-less pot is semi-rigid.

15. The garden ring system of claim 1, wherein said bottom-less pot is configured to be inserted approximately 4-inches into soil beneath said ground surface.

16. The garden ring system of claim 1, wherein said bottom-less pot comprises said inner cavity large enough to accommodate said plants.

17. A garden ring system comprising:
a planting apparatus including;
a bottom-less pot having;
an outer wall;
an inner cavity;
a first-opening; and
a second-opening;
wherein said garden ring system comprises said planting apparatus;
wherein said planting apparatus comprises said bottom-less pot;
wherein said bottom-less pot is defined by said outer wall, said inner cavity, said first-opening and said second-opening;
wherein said bottom-less pot comprises a cylindrical profile;
wherein said bottom-less pot is semi-rigid;
wherein said bottom-less pot comprises a thickness of approximately 0.125-inch;
wherein said first-opening comprises a rim configured to encircle a plant planted within said inner cavity;
wherein said first-opening and said second-opening comprise a circular profile;
wherein said rim comprises a greater diameter than said first-opening;
wherein said first-opening and said second-opening are similar in diameter, said second-opening slightly smaller than said first-opening;
wherein said second-opening comprises an open end and includes staggered edges configured to be inserted into a ground surface;
wherein said staggered edges comprise a w-shaped profile providing sharp edges for penetrating said ground surface;
wherein said second-opening is configured to permit and encourage horizontal root growth from said inner cavity of said bottom-less pot beneath said ground surface;
wherein said bottom-less pot comprises plastic creating a barrier for containing and retaining moisture and fertilizer within said inner cavity;
wherein said outer wall of said bottom-less pot comprises an identification tag slot for inserting at least one identification tag;
wherein said identification tag comprises indicia;
wherein said indicia indicates plant-types;
wherein said identification tag slot is located near a first-opening of said outer wall of said bottom-less pot;
wherein said bottom-less pot is configured to be inserted approximately 4-inches into soil beneath said ground surface;
wherein said bottom-less pot comprises said inner cavity large enough to accommodate said plants; and
wherein said plants are able to be planted into said inner cavity of said bottom-less pot and be inserted into said ground surface to retain moisture, fertilizer, and nutrients for optimal growth.

18. A method of planting comprising the steps of:
inserting a bottom-less pot into a ground surface;
applying downward pressure about a rim of a first-opening of said bottom-less pot; and
planting a plant within an inner cavity of said bottom-less pot;

19. The method of claim 18, further comprising the steps of:
removing said bottom-less pot.
